(19) United States
(12) Patent Application Publication
(10) Pub. No.: US 2012/0018236 A1
(43) Pub. Date: Jan. 26, 2012

(54) Electric powertrain for off-highway trucks

(75) Inventors: Suresh B. Reddy, Dunlap, IL (US); Philip C. McKenzie, Holly Springs, NC (US); Michael Krause, Manito, IL (US)

(73) Assignee: CATERPILLAR INC., Peoria, IL (US)

(21) Appl. No.: 13/190,992

(22) Filed: Jul. 26, 2011

Related U.S. Application Data
(62) Division of application No. 12/210,961, filed on Sep. 15, 2008, now abandoned.

(51) Int. Cl. B60K 6/00; B60K 6/46

(52) U.S. Cl. 180/65.245; 903/902

(57) ABSTRACT

An off-highway truck with an electric powertrain is provided. The off-highway truck includes a set of steerable idle wheels supported by a chassis. An engine is configured to provide the off-highway truck with mechanical energy. At least one electric power generator is operably coupled to the engine and configured to convert at least a portion of the mechanical energy provided by the engine into electric energy. At least one electric motor is operably coupled to the electric power generator. First and second final drives are configured to rotate at least one drive wheel that is non-steerable. A differential is operably coupled to the at least one electric motor for distributing the torque produced by the at least one electric motor to the first and second final drives.

### TECHNICAL FIELD

This patent disclosure relates generally to powertrains for off-highway trucks and, more particularly to an electric powertrain for an off-highway truck.

### BACKGROUND

Off-highway trucks are commonly used in mining, heavy construction, quarrying and other applications. In these applications, off-highway trucks can be called upon to transport heavy payloads up and down steep grades in both dry and wet conditions. Off-highway trucks may have payload capacities of 100 tons or more and travel at speeds of 40 miles per hour or more when fully loaded. Off-highway trucks typically include a set of drive wheels that propel the truck and a set of idle wheels that can be used to steer the off-highway truck.

Conventional off-highway trucks are generally powered using an internal combustion engine such as, for example, a diesel engine, a gasoline engine, or other internal combustion engines known in the art. Such internal combustion engines may emit undesirable exhaust emissions and other pollutants during operation. In recent years, and for the foreseeable future, the reduction of exhaust emissions for internal combustion engines in general and for machines in particular, has become a regulatory priority. Furthermore, increasing fuel efficiency of machines has also become of increased importance, for example, to reduce increased costs associated with the rising price of fossil fuels and/or reliance on imported oil.

Driven at least in part by new and future exhaust emissions regulations and a desire to reduce fuel consumption, alternative ways to power machines have been sought. One such alternative is the use of powertrains having electric components such as, for example, electric motors, generators, and electronic control systems. Such electric components have been used previously in some vehicle powertrain applications. The use of such electric components, however, in off-highway trucks may present a number of challenges not associated with other types of vehicles due to the applications in which off-highway trucks are used.

One powertrain arrangement for electric earth-moving and agricultural vehicles is disclosed in U.S. Pat. No. 6,615,946 (“the '946 patent”) issued to Pasquini et al. on Sep. 9, 2003. The '946 patent describes a powertrain for producing four-wheel drive including a pair of electric motors powered by battery sets. The electric motors connect to front and rear distribution shafts. A differential is fitted to the end of each distribution shaft from which axles protrude for the wheels. Both of the axles have respective steering elements. The powertrain arrangement of the '946 patent, however, does not apply to off-highway trucks that include a single driven set of wheels, nor does it address the powertrain design issues associated with the applications in which off-highway trucks are commonly used.

### SUMMARY

The disclosure describes, in one aspect, an off-highway truck. The off-highway truck includes a set of steerable idle wheels supported by a chassis. An engine is configured to provide the off-highway truck with mechanical energy. At least one electric power generator is operably coupled to the engine and configured to convert at least a portion of the mechanical energy provided by the engine into electric energy. At least one electric motor is operably coupled to the electric power generator. First and second final drives are configured to rotate at least one drive wheel that is non-steerable. A differential is operably coupled to the at least one electric motor for distributing the torque produced by the at least one electric motor to the first and second final drives.

In another aspect, the disclosure describes an off-highway truck having an engine configured to provide mechanical energy. At least one electric power generator is operably coupled to the engine and configured to convert at least a portion of the mechanical energy provided by the engine into electric energy. At least one electric motor is operably coupled to the electric power generator. A multiple range gear box is operably coupled to the at least one electric motor. First and second final drives are configured to rotate at least one drive wheel. A differential is operably coupled to the multiple range gear box for distributing a torque output from the multiple range gear box to the first and second final drives.

In another aspect, the disclosure describes an off-highway truck including an engine configured to provide mechanical energy. At least one electric power generator is operably coupled to the engine and configured to convert at least a portion of the mechanical energy provided by the engine into electric energy. A first electric motor and a second electric motor operably are coupled to the electric power generator. A first multiple range gear box is operably coupled to the first electric motor and a second multiple range gear box is operably coupled to the second electric motor. A first final drive is operably coupled to the first multiple range gear box and a second final drive is operably coupled to the second multiple range gear box, the first and second final drives each being configured to rotate at least one drive wheel.

### BRIEF DESCRIPTION OF THE DRAWINGS

FIG. 1 is a side view of an off-highway truck in accordance with the disclosure.

FIG. 2 is a block diagram of an electric powertrain of an off-highway truck in accordance with the disclosure.

FIG. 3 is a block diagram of an electric powertrain of a off-highway truck according to another exemplary disclosed embodiment.

FIG. 4 is a block diagram of an electric powertrain of a off-highway truck according to an additional exemplary disclosed embodiment.

### DETAILED DESCRIPTION

This disclosure relates to an electric powertrain for an off-highway truck. The disclosed electric powertrain may provide reduced fuel consumption as compared to off-highway truck powertrains using only internal combustion engines because the electric components of the powertrain may provide infinitely variable speed control. Moreover, the use of the electric components may provide reduced exhaust emissions as compared to powertrains driven solely by an internal combustion engine.

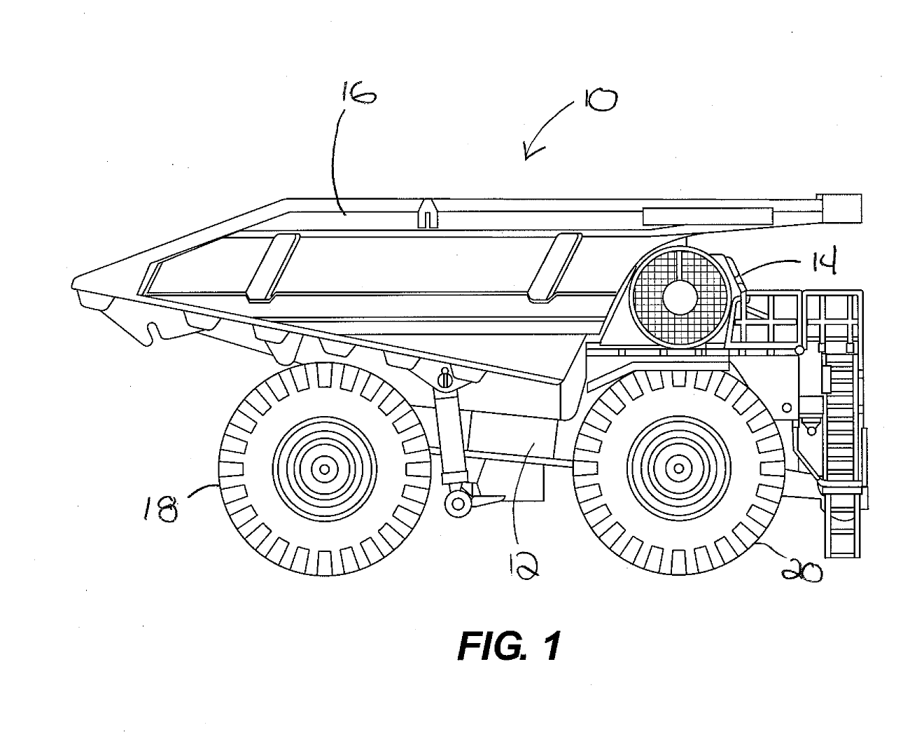

FIG. 1 illustrates an exemplary off-highway truck 10. The off-highway truck 10 includes a chassis 12 that supports an operator cab 14 and a bucket 16. The bucket 16 is pivotally connected to the chassis 12 and is arranged to carry a payload when the off-highway truck 10 is in service. An operator occupying the operator cab 14 can control the motion and the various functions of the off-highway truck 10. The chassis 12 supports various drive system components. These drive system components are capable of driving a set of drive wheels 18 to propel the off-highway truck 10. A set of idle wheels 20 can steer using known methods such that the off-highway truck 10 can move in any direction. In this case, the drive wheels 18, which are non-steerable, are arranged at the rear of the chassis 12 and the idle wheels 20 are arranged at the front of the chassis 12. Even though the off-highway truck 10 includes a rigid chassis with powered wheels for motion and steerable wheels for steering, one can appreciate that other machine configurations can be used. For example, such configurations may include articulated chassis with one or more driven wheels.

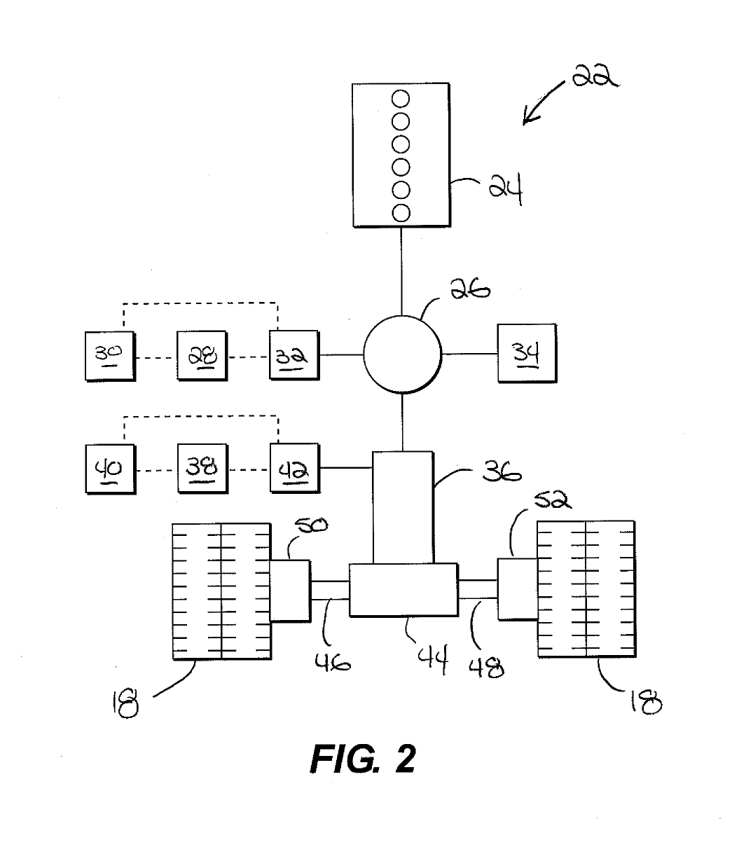

Referring to FIG. 2, the off-highway truck 10 may include an electric powertrain 22 having an engine 24, for example, a diesel engine, a gasoline engine, a natural gas engine, a gas-turbine engine, or any other engine known in the art, for providing the off-highway truck 10 with mechanical energy. The engine 24 is operatively associated with an electric power generator 26 and may drive the electric power generator 26 such that the electric power generator converts the mechanical energy from the engine into electric energy. The electric power generator 26 may be any known AC or DC generator such as, permanent magnet, induction, switched-reluctance, or a hybrid combination of the above, and may also be sealed, brushless, and/or liquid cooled, for example, to provide a more durable design.

The electric power generator 26 may have associated power electronics 28 and a generator controller 30 operably coupled to a generator sensor 32, for example, a speed sensor that is, in turn, operably coupled to the electric power generator 26. The power electronics 28 may include a power inverter, an inverter controller, and/or generator software configured to control the conversion of at least a portion of the mechanical energy into electric energy. As an alternative, the electric power generator 26 may include a rectifier in place of the power electronics and not require a speed sensor based on the control logic used. The generator controller 30 may be configured to control the conversion of alternating current from the electric power generator 34 into a high voltage direct current and may monitor the electric power generator's operation via the generator sensor 32.

The electric powertrain 22 may also include an electric energy storage system 34 such as, for example, a battery and/or an ultra-capacitor, or flywheel, for storing any excess electric energy generated by the electric power generator 26 and/or for providing any additional electric energy that may be needed when starting and/or during operation of the off-highway truck 10. For example, when the off-highway truck 10 is operating in a low load condition, the engine 24 may continue to run at a given engine speed or engine speed range. In such relatively low load conditions, it may be possible to operate the off-highway truck 10 more efficiently and the electric power generator 26 can continue to convert mechanical energy into electric energy, which may be stored in the electric energy storage system 34. Alternatively, for a situation in which the off-highway truck 10 is traveling, for instance, up a relatively steep grade with a fully loaded bucket 16, the electric energy storage system 34 may provide additional energy beyond the electric energy being generated by the electric power generator 34, and may prevent the engine 24 from lugging down or stalling.

The electric power generator 26 may be used to provide electric energy to power an electric motor 36. Although referred to in the singular, more than one electric motor may be used, and the schematic depiction in FIG. 2-4 of the electric motors may represent more than one electric motor such as, for example, two or more electric motors mechanically combined via a gear or gear train. Multiple electric motors 26 that are driven in parallel and connected mechanically may be used in order to minimize drive train inertia. Each of the electric motors 26 may have different performance characteristics. For instance, each of the electric motors 26 may be of a different size or they may be wound differently. The electric motor 26 may be any known AC or DC motor such as, permanent magnet, induction, switched-reluctance, or a hybrid combination of the above, and may also be sealed, brushless, and/or liquid cooled.

The electric powertrain 22 may further include power electronics 38 operably coupled to the electric motor 46 and at least one motor controller 40 and/or a motor sensor 42, for example, a speed sensor. However, the speed sensor may not be needed based on the control logic used. The power electronics 38 may include a power converter, an inverter controller, and/or motor software, and may be configured to convert and control electricity provided to the electric motor 36, thereby providing control of speed and torque for the propulsion of the off-highway truck 10. The electric powertrain 22 may further include a master controller configured to control the engine 24, electric power generator 26, generator controller 30, electric energy storage system 34, and/or motor controller 40 such that the electric powertrain may be operated in a coordinated and controlled fashion.

Braking devices may be provided that are configured to selectively apply a braking force resulting in a slowing of either or both of the drive wheels. Alternatively, or in addition, the electric motor 46 may operate as a generator, and the electric power generator 26 may operate as a motor, for example, during the braking of the off-highway truck 10 and/or during the slowing of the electric motor 36 and/or electric power generator 26. For example, the electric motor 36 may be configured and controlled such that the off-highway truck 10 may be slowed while using the electric motor 36 as a generator, thereby converting kinetic energy associated with the off-highway truck 10 into electric energy, which may be stored in the electric energy storage system 34. In addition, the electric motor's inertia and speed may also be converted into electric energy during slowing of the electric motor 36. The electric power generator 26 may also operate as a motor, for example, to provide an input back into the engine 24 so as to over speed the engine during periods in which the electric powertrain 22 experiences an excess in energy. This may act to reduce fuel consumption and/or emissions from the engine 24. As an alternative, such excess energy may be dissipated across a resistive grid.

By virtue of receiving electric energy from the electric power generator 26 and/or the electric energy storage system 34, the electric motor 36 may create a torque at its output shaft. The output shaft of the electric motor 36 may, in turn, be operably coupled to a differential 44 either directly as shown in FIG. 2 or via a drive shaft. The differential 44 distributes the torque produced by the electric motor 36 to first and second axles 46, 48 that extend towards opposite sides of the off-highway truck 10. The first and second axles 46, 48 may be operably coupled to respective first and second final drives 50, 52, each of which may comprise a gear assembly and may be configured to rotate one or more of the drive wheels 18. In the embodiment illustrated in FIG. 2, the first and second final drives 50, 52 are arranged on opposite sides of the off-highway truck 10 and are configured to rotate a pair of corresponding drive wheels 18. The disclosed electric powertrain may include other configurations and numbers of drive shafts and axles.

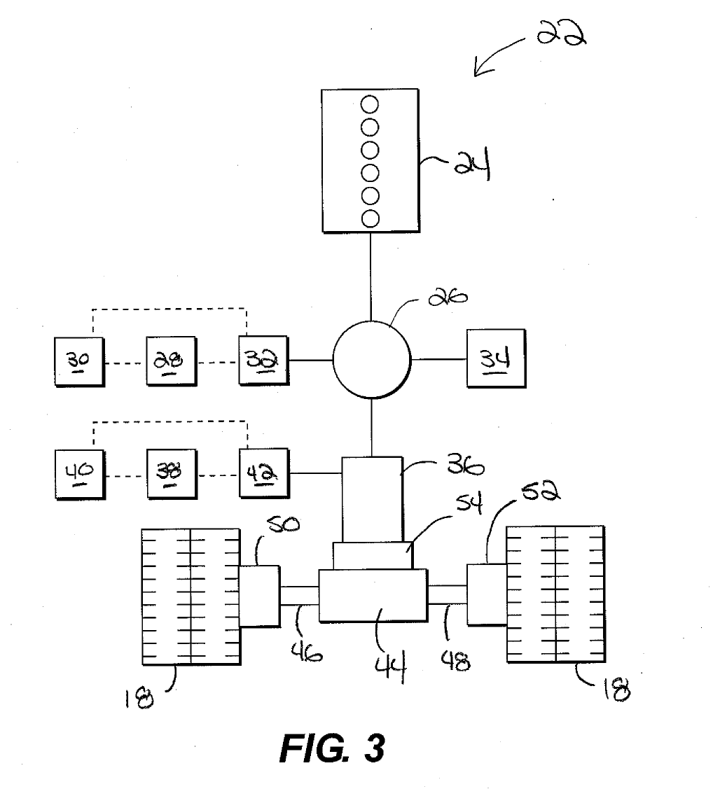

According to some embodiments, a multiple range gear box 54 or transmission may be provided that is operably coupled to the electric motor 36, for example, as shown in FIG. 3. The multiple range gear box 54 may be interposed between the electric motor 36 and the differential 44 and be capable of adjusting the output speed and torque from the electric motor 36 to multiple ranges or settings, for example two or three speed and torque settings. The use of a multiple range gearbox 54 in combination with the final drives 50, 52 may enable the use of one or more smaller electric motors and/or less complicated and/or costly power electronics.

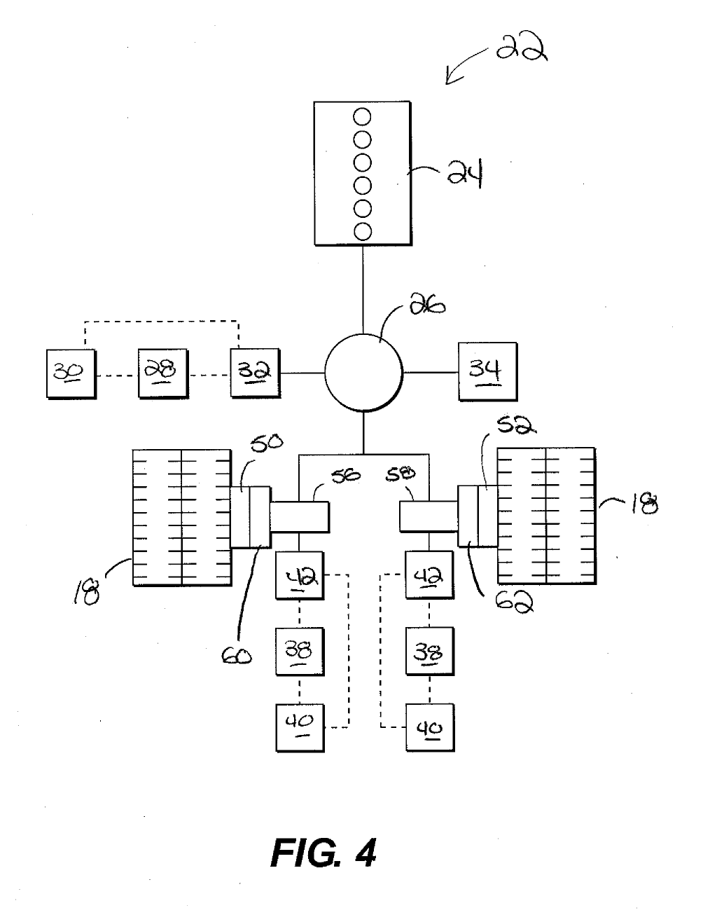

According to another embodiment, the electric power generator 26 may be operably coupled to first and second drive motors 56, 58 with each motor being configured to drive the drive wheels 18, in this case, on one side of the off-highway truck 10 as shown in FIG. 4. Again, as with the embodiments of FIGS. 2 and 3, the first and second electric motors 56, 58 may each comprise more than one electric motor. In the embodiment of FIG. 4, the first electric motor 56 is operably coupled to a first multiple range gear box 60 or transmission that, in turn, is operably coupled to the first final drive 50. Likewise, the second electric motor 58 is operably coupled to a second multiple range gear box 62 or transmission that, in turn, is operably coupled to a second final drive 52. Each of the first and second final drives 50, 52 is configured to rotate one or more drive wheels 18. Similar to the embodiment of FIG. 3, the provision of a multiple range gearbox and final drive with each of the first and second electric motors allows for higher gear reductions allowing for the use of relatively smaller electric motors.

### INDUSTRIAL APPLICABILITY

The disclosed electric powertrain arrangements may be applied to off-highway trucks of any size and any configuration. Additionally, the disclosed electric powertrain arrangements may allow the use of smaller, and thus lower weight and lower cost, electrical components than powertrain arrangements that utilize electric drive motors at each wheel. In particular, smaller, lower weight and lower cost electric motors and associated power electronics may be used in the powertrain.

In the disclosed powertrain arrangements, the use of a central electric motor or motors that drives the drive wheels of the off-highway truck itself reduces the weight and cost of the powertrain as compared to the use of electric drive motor at each wheel. Additionally, the use of final drives with or without a differential may allow higher gear reductions, which further enables the use of even smaller electric motors. The use of a multi-range gear box as disclosed in the embodiments of FIGS. 3 and 4 may allow a further reduction in the size of the electric motors. The use of a gearbox may also enable the electric powertrain to more closely approximate the features, weight, size and cost of a traditional mechanical powertrain powered by an internal combustion engine while still maintaining some of the advantages of an electric powertrain. Such advantages may include electric retarding and a continuously variable drive.

It will be appreciated that the foregoing description provides examples of the disclosed system and technique. However, it is contemplated that other implementations of the disclosure may differ in detail from the foregoing examples. All references to the disclosure or examples thereof are intended to reference the particular example being discussed at that point and are not intended to imply any limitation as to the scope of the disclosure more generally. All language of distinction and disparagement with respect to certain features is intended to indicate a lack of preference for those features, but not to exclude such from the scope of the disclosure entirely unless otherwise indicated.

Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context.

1. An off-highway truck comprising:
a chassis;
a bucket supported on the chassis;
a set of steerable idle wheels supported by the chassis;
an engine configured to provide the off-highway truck with mechanical energy;
at least one electric power generator operably coupled to the engine and configured to convert at least a portion of the mechanical energy provided by the engine into electric energy;
at least one electric motor operably coupled to the electric power generator;
a first final drive and a second final drive, the first and second final drives each being configured to rotate at least one drive wheel that is non-steerable; and
a differential operably coupled to the at least one electric motor for distributing the torque produced by the at least one electric motor to the first and second final drives.

2. The off-highway truck of claim 1 wherein a multiple range gear box is operably coupled to the at least one electric motor.

3. The off-highway truck of claim 1 further including an electric energy storage system for storing any excess electric energy generated by the electric power generator.

4. The off-highway truck of claim 1 wherein the electric power generator is configured to also act as a motor.

5. The off-highway truck of claim 1 wherein the at least one electric motor is configured to also act as a generator.

6. The off-highway truck of claim 1 wherein the off-highway truck includes two electric motors operably coupled to the electric power generator.

7. The off-highway truck of claim 2 wherein the multiple range gear box includes two settings.

8. The off-highway truck of claim 2 wherein the multiple range gear box includes three settings.

9-20. (canceled)
